(19) United States
(12) Patent Application Publication
(10) Pub. No.: US 2020/0183976 A1
(43) Pub. Date: Jun. 11, 2020

(54) METHOD AND APPARATUS FOR ANALYSING VIDEO CONTENT IN DIGITAL FORMAT

(71) Applicant: Metaliquid S.R.L., Milano (IT)

(72) Inventor: Simone BRONZIN, Vidigulfo (PV) (IT)

(73) Assignee: Metaliquid S.R.L., Milano (IT)

(21) Appl. No.: 16/614,386

(22) PCT Filed: May 17, 2018
(86) PCT No.: PCT/IB2018/053460

§ 371 Date: Nov. 18, 2019

(30) Foreign Application Priority Data
May 17, 2019 (IT) 102017000053345

(51) Int. Cl. G06F 16/783; G06N 3/04; G06N 3/08; G06K 9/00; G06K 9/62

(52) U.S. Cl. CPC G06F 16/7834; G06N 3/0454; G06K 9/6263; G06K 9/00718; G06N 3/08

(57) ABSTRACT

Method for analysing video content in digital format comprising: identifying a plurality of portions, each corresponding to a respective shot, in a video (VC); activating a processor (120) to read, from a memory (130) associated with said processor (120), reference parameters (RP); activating said processor (120) to compare each of said portions with said reference parameters (RP), obtaining a semantic representation associated with said portion; activating said processor (120) to associate a time reference within said video (VC) with each of said semantic representations; generating an output signal (OUT) containing the semantic representations obtained from said video (VC) and the time references associated with them.

### TECHNICAL FIELD

The object of the present invention is a method and equipment for analysing video in digital format.

### PRIOR ART

As is known, in the presence of a large quantity of video, for example in digital format, it is important to be able to catalogue it in an effective manner so as to be able to find the content of interest in any situation.

This issue is particularly felt for example, by those who provide video content by means of broadband connections and/or broadcast transmission.

The content of this kind currently is catalogued substantially using two sources of information:

data of “bibliographical” nature, provided by the producer together with the video, which may comprise title, type, brief description of the plot, main actors/actresses, length, etc.;

the reviews on the web and commenting the content in question.

It is therefore apparent that cataloguing large quantities of content based on these two types of information alone is not very effective and to a large extent, not very objective.

Indeed, few objective data are available (the aforesaid information of “bibliographical” nature), and the rest refer to comments, opinions, judgements expressed on the content, more than a description that in some manner is objective and suitable for creating a catalogue.

The Applicant has therefore noticed that no system is available to date that allows managing the management/search/recommendation of video content in digital format in an adequate manner.

### OBJECTS AND SUMMARY OF THE INVENTION

It is the object of the present invention to make available a method and equipment that allow managing video content in digital format in an adequate manner so as to be able to search for and/or recommend them in an effective and accurate manner.

These and other objects again are substantially achieved by a method and by equipment for analysing video in digital format, as described in the appended claims.

### BRIEF DESCRIPTION OF THE DRAWINGS

Further features and advantages shall be more apparent from the detailed description of preferred, but not exclusive, embodiments of the invention.

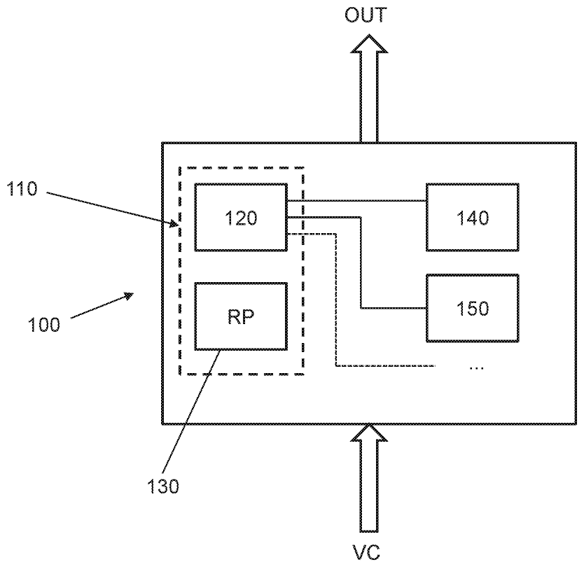

Such description is made herein below with reference to the accompanying FIG. 1, also provided for indicative purposes only, and therefore not limiting, in which there is shown a block diagram of equipment in accordance with the present invention.

### DETAILED DESCRIPTION OF THE INVENTION

With reference to FIG. 1, an apparatus for analysing video in digital format is indicated as a whole with 100.

The apparatus 100 firstly comprises a computer 110 dedicated to coordinating the processing, and a group of other components (exemplified in FIG. 1 by modules 140 and 150)—dedicated to the processing. The computer 110 comprises a memory 130 and a processor 120, which may be of any type suitable for being programmed so as to execute the operations that are described below. The memory 130, associated with the processor 120, is used to store the data that the processor 120 uses and/or generates during its processing operations.

In accordance with the invention, firstly a video content VC in digital format is provided. Such content may be for example, a movie, a video, the depiction of a TV programme or a part of it, etc.

The processor 120 divides the video content VC into sequences of reduced time length and sends them to the modules 140, 150, etc. by means of network apparatuses, which may accordingly process them in parallel. The modules 140, 150 identify signals within the video content VC that once sent to the computer 110 again, allow identifying a plurality of portions. Each portion corresponds to a respective shot. In other words, every time a change of shot within the video content is detected, a new portion is identified. Therefore, each portion is delimited by the content detected/generated by means of a given shot. In particular cases, if the shot is excessively lengthy, it is provided for several consecutive portions to be defined, made with the same shot.

It is worth noting that FIG. 1 shows, by way of example, two modules 140, 150 that operate in parallel to cooperate in identifying the aforesaid portions. It is in any case provided also for a different number of modules to be provided to perform this function.

The processor 120 therefore reads, from the memory 130, reference parameters RP saved previously.

As is apparent below, the reference parameters RP are used to carry out a semantic analysis of what is depicted in each video content portion.

In other words, the processor 120 generates a semantic representation associated with each portion thanks to a comparison with the aforesaid reference parameters RP.

By way of example, such semantic representation comprises at least one among:

a) persons and/or objects present in said portion;

b) a location in said portion;

c) a description of the type of action that is carried out in said portion.

In accordance with the invention, the semantic representation associated with one or more of the aforesaid portions is relative to an action/situation that develops dynamically over time within the video portion itself.

In greater detail, the following steps preferably are performed:

two or more elements are recognised within the frame sequence;

an analysis is carried out on how, over time and space, the relationship varies between such recognised elements, within the video portion.

By mere way of example, consider a passing action in a car race: in addition to identifying the two (or more) cars shot, the evolution of the mutual position between them is analysed. Based on such evolution, it is possible to recognise the passing action.

In terms of the data structure, a semantic graph may be made, in which the various elements present in the video portion and the relationships between them are depicted.

The reference parameters RP are representative of possible semantic representations of each of the video portions.

In particular, the reference parameters RP may be used to recognise the individual elements present in the video portion (e.g. the cars in the example above), and to recognise what happens from a “narrative” viewpoint, that is which changes occur in the video portion with reference to the elements identified (e.g. a car is initially behind another one and changes position, over time, so as to be in front).

By comparing the results of the aforesaid analysis with the reference parameters RP, it is possible to identify the semantic representation that may be associated with a video portion.

Advantageously, the reference parameters RP are defined by carrying out a progressive learning step of one or more neural networks.

To this end, such one or more neural networks is provided with respective one or more test sequences, the content of which is known beforehand. The neural networks therefore generate feedback signals (that is an output) generated based on said one or more test sequences created by a human operator. By knowing the content of the test sequences and analysing the feedback signals provided, an automatic system may proceed with an iterative correction of said one or more neural networks so as to progressively refine the capacity of such neural networks to recognise the content of the input video sequences.

Once the learning step is completed, the neural networks may be used at an operating level to analyse video content not known beforehand and provide the relative semantic representations.

When the neural network receives an input video content to be analysed, it virtually determines the distance—according to a predetermined metric—between what is depicted in each portion of the video content and the reference parameters RP.

Such distance is representative of a difference between what is depicted in the analysed video content and the reference parameters RP obtained during the learning step based on known content.

When the distance between an analysed content portion and a pre-set model is less than a given threshold, then the system decides that the same entity depicted by said pre-set model is shown in the content portion. This results in defining the semantic representation for such content portion.

In one embodiment of the invention if, after the comparison between one video content portion and the reference parameters RP, no semantic representation is identified for said portion, then the processor 110 is activated to generate new reference parameters RP′ based on such portion. In practice, the video content portion that could not be classified is used as new “test sequence” to allow an increase of the knowledge of the system. The intervention by a human operator is clearly necessary for this step because the classification of the unclassified portion is necessary to proceed with a further learning of the neural networks. The intervention of the operator is supported by a statistic of the classifications automatically generated on other portions of the same video which presumably will be classified close to the unclassified portion.

In addition to that above, the processor 120 associates a time reference to each of the aforesaid portions. Such time reference is such as to allow the identification of the portion within the whole video content.

By way of example, said time references refer to at least one from the length of the video content, the start of the video content, the end of the video content.

The processor 110 may therefore generate an output signal OS containing the semantic representation and the respective time reference.

Thereby, once all the semantic representations and the time references of the video content portions are collected, it is possible to quickly and effectively trace back to the presence, for example, of given subjects or entities within a whole video.

In one embodiment, the semantic representations of the video portions may be obtained also as a function of audio content associated with such portions.

In practice, such audio content may be formed by portions of audio tracks that are replicated together with the aforesaid video portions during a use of the content.

Preferably, the audio content is processed by means of a speech-to-text function so as to obtain an easily processable transposition of such audio content.

It is worth noting that preferably texts already provided with subtitles, are not used. Indeed, the latter typically are subjected to certain censorship processes (e.g. to eliminate excessively vulgar words/expressions), so that an analysis of the content of such subtitles does not allow having a complete and in-depth knowledge of the features of the content itself.

In accordance with one aspect of the invention, the above semantic representation of the video content may advantageously be used for profiling users.

In greater detail, a user profile is initially provided. Such user profile comprises information relative to the user him/herself, which may include data representing user preferences, defined based on previous choices made or actions carried out by the user him/herself.

Such user is then provided with a video content analysed as described above, that is a video content whereby a semantic representation associated with a time reference was generated for each portion.

Then an action executed by the user during the use of such video content, is detected. By mere way of example, such an action may be an interruption of the use without resuming, an activation of the fast-forward function, a repetition of the reproduction of a given part, etc. In general, typically it is an action carried out by means of one's remote control, aiming to interfere in some manner with the regular reproduction of the content.

Thanks to the information acquired previously, it is possible to identify in which content portion the action was executed, and therefore to trace back to the semantic representation of such portion.

Thus, by assessing the type of action carried out and the content that was being reproduced when the action was carried out, it is possible to deduce useful information on the user's tastes such as to update the aforesaid user profile and improve for example, the accuracy and effectiveness with which the content is proposed to the user him/herself.

The invention achieves important advantages.

Firstly, the analysis system in accordance with the invention is objective, that is it allows classifying a video content based on real information actually present in the video itself. This translates into for example, an accurate, precise and reliable management of the video content processed with the technique the object of the present invention.

Moreover, the analysis method according to the invention may be executed in a simple and quick manner, for example also in real time, during the use of the content itself.

In addition to that above, the invention allows the direct enhancement and management of the content, something otherwise impossible to achieve with the methods known to date based for example, on purely human analysis.

The invention also allows an effective profiling of the users of the video content and accordingly allows providing increasingly personalised services and improving the overall user experience.

The invention also allows identifying a broad class of objects and actions, thus making the system accurate and reliable.

1. Method for analysing video content in digital format comprising:
a) identifying a plurality of portions, each corresponding to a respective shot, in a video (VC);
b) activating a processor (120) to read, from a memory (130) associated with said processor (120), reference parameters (RP);
c) activating said processor (120) to compare each of said portions with said reference parameters (RP), obtaining a semantic representation associated with said portion;
d) activating said processor (120) to associate a time reference within said video (VC) with each of said semantic representations;
e) generating an output signal (OUT) containing the semantic representations obtained from said video and the time references associated with them
wherein said semantic representation comprises a description of an action that is carried out in said portion.

2. Method according to claim 1 comprising:
a) activating processor (120) to identify, in said video portion, two or more elements;
b) activating said processor (120) to carry out an analysis on how, over time and space, the relationship varies between such elements, within the video portion.
c) obtaining, based on said analysis, the semantic representation associated with at least one of said video portions.

3. Method according to claim 1 wherein said reference parameters (RP) are defined by carrying out a progressive learning step of one or more neural networks.

4. Method according to claim 3 wherein said learning step comprises:
a) providing said one or more neural networks with respective one or more test sequences;
b) generating, through said one or more neural networks, feedback signals generated based on said one or more test sequences;
c) correcting said one or more neural networks as a function of said feedback signals.

5. Method according to claim 3 wherein the step of comparing the portions of said video with reference parameters (RP) comprises inputting said video portions to said one or more neural networks.

6. Method according to claim 5 wherein the portions of said video (VC) are provided to said one or more neural networks after said one or more neural networks have ended the respective learning.

7. Method according to claim 1 wherein comparing the portions of said video (VC) with reference parameters (RP) comprises:
a) Providing a metric for measuring a difference between a video portion (VD) and said reference parameters (RP);
b) calculating, based on said metric, a distance between each of said portions and said reference parameters (RP).

8. Method according to claim 7 wherein the semantic representation of each of said portions is determined as a function of said calculated distance.

9. Method according to claim 1 wherein if, after the comparison between one of said portions and said reference parameters (RP), no semantic representation is identified for said portion, then said processor (120) is activated to generate new reference parameters based on said portion.

10. Method according to claim 1 wherein said time references refer to at least one from the length of said video, the start of said video, the end of said video.

11. Method according to claim 1 also comprising:
a) Identifying audio content associated with said portions of video content (VC);
b) Carrying out a semantic analysis of said audio content;
c) Determining the semantic representations associated with said portions of video content also as a function of the semantic analysis carried out on the respective audio content.

12. Method for profiling a user, comprising:
a) providing a user profile;
b) supplying said user with a content treated with the method in accordance with claim 1;
c) detecting an action carried out by said user during the use of said video;
d) identifying the portion of video during which said action was detected;
e) identifying the semantic representation associated with said identified portion;
f) modifying said profile as a function of said identified semantic representation.

13. Apparatus for analysing video content in digital format comprising a processor (120) and a memory (130) associated with said processor (120), wherein said memory contains reference parameters (RP), wherein said processor (120) is configured to:
a) identify a plurality of portions, each corresponding to a respective shot, in a video (VC);
b) read said reference parameters (RP) from said memory (130);
c) compare each of said portions with said reference parameters (RP), obtaining a semantic representation associated with said portion;
d) associating a time reference within said video (VC) with each of said semantic representations;
e) generating an output signal (OUT) containing the semantic representations obtained from said video and the time references associated with them
wherein said semantic representation comprises a description of an action that is carried out in said portion.
